(19) United States
(12) Patent Application Publication
(10) Pub. No.: US 2007/0063119 A1
(43) Pub. Date: Mar. 22, 2007

(54) Hanging device for various objects

(76) Inventor: Ching Yun Huang, Changhua Hsien (TW)

Correspondence Address: CHARLES E. BAXLEY, ESQ., 90 JOHN STREET, THIRD FLOOR, NEW YORK, NY, 10038, US

(21) Appl. No.: 11/190,524

(22) Filed: Jul. 28, 2005

(51) Int. Cl. F16B 45/00

(52) U.S. Cl. 248/304

(57) ABSTRACT

A hanging device includes a base support member having one or more openings and one or more notches and a depression communicating with each other, and an attachment includes a shank for engaging into the opening of the base support member, and includes one or more protrusions laterally extended from the shank, for engaging into the notches and then into the depression of the base support member by rotating the attachment relative to the base support member, for detachably locking the attachment to the base support member. The base support member includes a cavity, and the attachment includes one or more projections for engaging into the cavity of the base support member, and for detachably locking the attachment to the base support member.

### BACKGROUND OF THE INVENTION

1. Field of the Invention

The present invention relates to a hanging device, and more particularly to a hanging device having a solid coupling or securing structure for solidly and detachably securing various objects to a support base member.

2. Description of the Prior Art

Typical hanging devices comprise a support base or wall panel including a number of slots or orifices formed therein, and one or more objects each including one or more projections or connectors extended therefrom, for engaging into the slots or orifices of the support base or wall panel, and for detachably attaching the objects onto the support base or wall panel.

For example, U.S. Pat. No. 4,401,222 to Kulikowski et al. discloses one of the typical hanging devices comprising a paper handling tray having a hook-shaped flange provided on the rearward upper edge thereof, for engaging with upwardly projected lip member of a hollow rail member, and thus for detachably attaching to the hollow rail member. The hollow rail member includes one or more projections or connectors extended therefrom, for engaging into the slots or the orifices of a support base member or a wall panel, and for detachably attaching the objects onto the support base or wall panel.

However, the hook-shaped flange of the paper handling tray is simply engaged with upwardly projected lip member of the hollow rail member, and the projections or connectors of the hollow rail member are also simply engaged into the slots or orifices of the support base or wall panel, such that the paper handling tray may have a good chance to be disengaged from the hollow rail member, and the hollow rail member may also have a good chance to be disengaged from the support base or wall panel.

U.S. Pat. No. 4,771,897 to Ho discloses one of the typical key hanging device comprising one or more sliding members slidably attached onto a frame member, and each having a hook extended therefrom for hanging an identification board or the like. However, similarly, the identification board may not be solidly attached to the sliding members of the frame member, and also may have a good chance to be disengaged from the sliding members of the frame member.

The present invention has arisen to mitigate and/or obviate the afore-described disadvantages of the conventional hanging devices.

### SUMMARY OF THE INVENTION

The primary objective of the present invention is to provide a hanging device including a solid coupling or securing structure for solidly and detachably securing various objects to a support base member.

In accordance with one aspect of the invention, there is provided a hanging device comprising a base support member including at least one opening formed therein, and at least one notch formed therein and located beside and communicating with the opening thereof, and including a depression formed in a rear portion thereof, and communicating with the notch thereof, and an attachment including a shank extended therefrom for engaging into the opening of the base support member, and including at least one protrusion laterally extended from the shank, for engaging into the notch of the base support member, and for engaging into the depression of the base support member by rotating the attachment relative to the base support member, and for detachably locking the shank of the attachment to the base support member.

The base support member includes a cavity formed in the rear portion thereof, and communicating with the depression and the notch of the base support member, and the attachment includes at least one projection extended from the protrusion, for engaging into the cavity of the base support member, and for detachably locking the shank of the attachment to the base support member, and for preventing the shank of the attachment from being disengaged from the base support member.

The attachment may either be a hook member, a numeral member, a circular member, an arrow member, or the like. The base support member includes at least one magnet attached to the rear portion thereof. The base support member may further include an adhesive layer attached to the magnet. The base support member may include a recess formed in the rear portion thereof, for receiving the magnet, which may be used for detachably securing or attaching the base support member to various objects, such as wall members.

The base support member includes at least one aperture formed in the rear portion thereof, for receiving a fastener, a nail, or a sucker member, or the like, for securing the base support member to various objects, such as wall members.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a hanging device in accordance with the present invention, as seen from the front portion of the hanging device;

FIG. 2 is another partial exploded view of the hanging device, as also seen from the front portion of the hanging device;

FIG. 3 is a further partial exploded view of the hanging device, as seen from the rear portion of the hanging device;

FIGS. 4, 5 are enlarged partial perspective views of the hanging device;

FIG. 6 is a partial plan view of the hanging device;

FIG. 7 is another partial plan view similar to FIG. 6, illustrating the operation of the hanging device;

FIGS. 8, 9 are partial cross sectional views of the hanging device, taken along lines 8-8 and 9-9 of FIGS. 6, 7 respectively; and

FIGS. 10, 11, 12, 13, 14 are perspective views illustrating various applications or arrangements of the hanging device.

### DETAILED DESCRIPTION OF THE PREFERRED EMBODIMENT

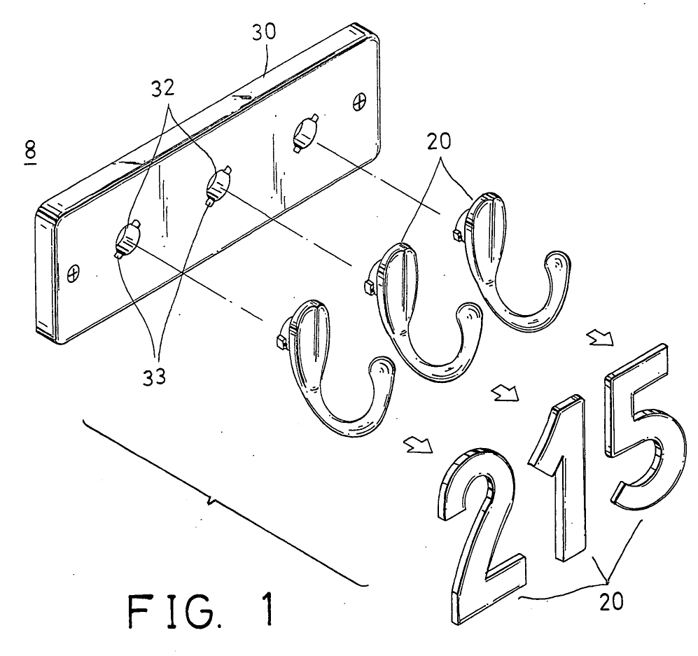

Referring to the drawings, and initially to FIGS. 1-3, a hanging device in accordance with the present invention comprises one or more objects or elements or attachments 20 for selectively attaching to or for engaging with a base support member 30. The base support member 30 includes one or more apertures 31 formed therein, for receiving nails 40, fasteners 50, or sucker members 60, and thus for securing the base support member 30 onto various objects 8 (FIG. 1) or walls or the like.

The base support member 30 includes one or more openings 32 formed therein, and one or more, such as two notches 33 formed therein and located beside and communicating with each of the openings 32 respectively. As best shown in FIG. 3, it is preferable that the base support member 30 includes a recess 34 formed in the rear portion thereof, for receiving one or more magnets 35 and/or adhesive layers 36 which may be used to detachably or solidly attaching or securing the base support member 30 onto the objects 8 or walls or the like.

As best shown in FIG. 4, the base support member 30 further includes one or more depressions 37 and one or more cavities 38 formed in the rear portion thereof, and communicating with each other, and communicating with the notches 33 respectively.

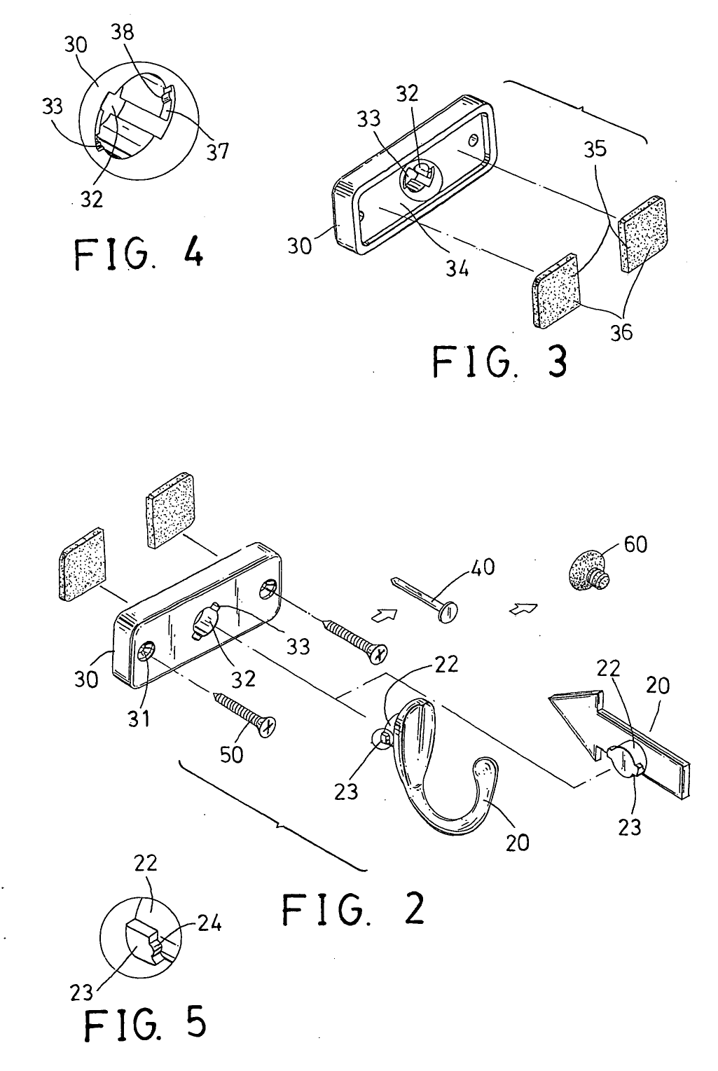

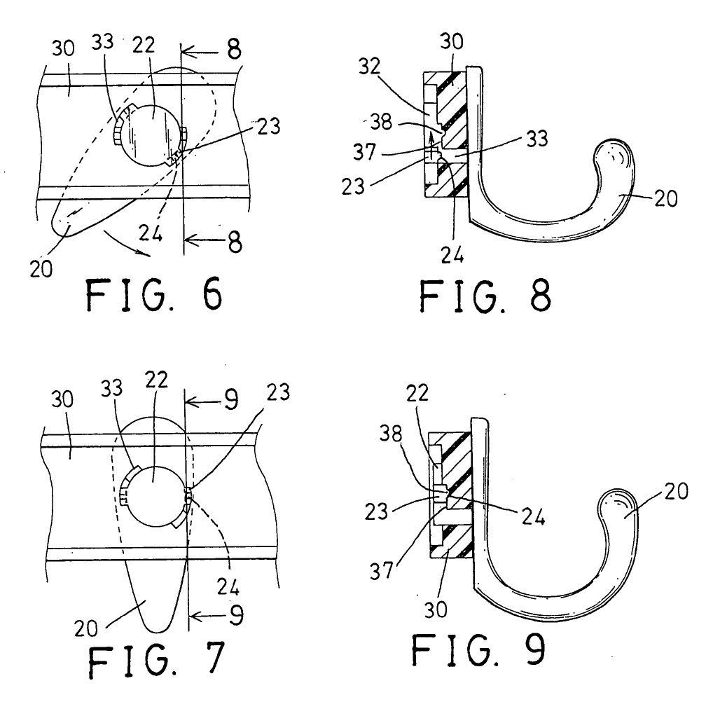

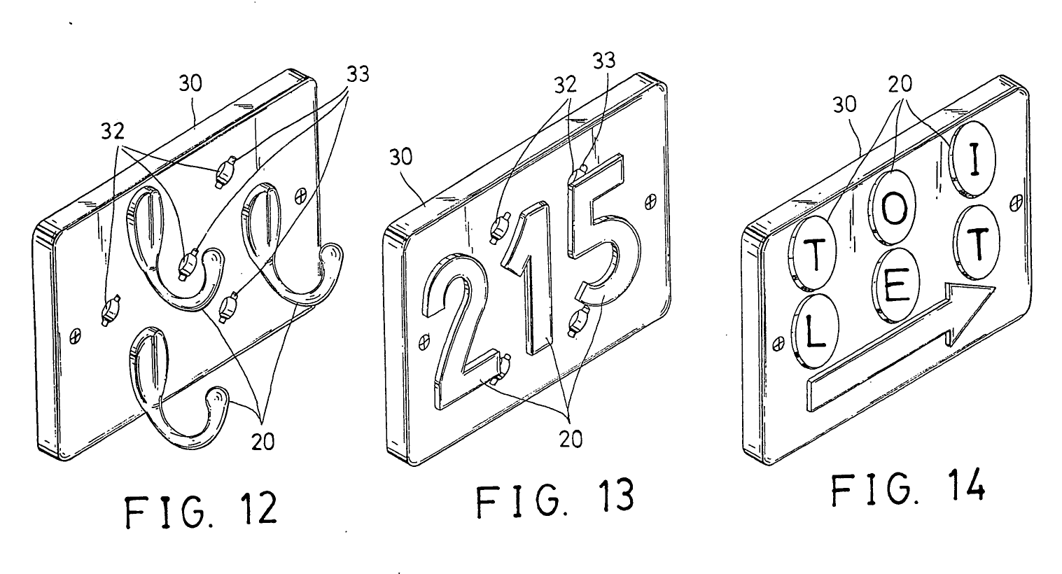

The attachments 20 may include a hook-shaped configuration as shown in FIGS. 1, 2, 8-10 and 12, a numeral configuration as shown in FIGS. 1, 11, 13, an arrow-shaped configuration as shown in FIGS. 2 and 14, and/or a circular-shaped configuration as shown in FIG. 14, or the like, and each may include a shank 22 extended therefrom, for engaging into or through either of the openings 32 of the base support member 30, and each further includes one or more, such as two protrusions 23 laterally extended therefrom, for engaging into the depressions 37 of the base support member 30, when the shank 22 of the attachment 20 is rotated relative to the base support member 30, and thus for force-fitting or detachably locking or releasably securing the shank 22 of the attachment 20 to the base support member 30 (FIGS. 6-9).

It is preferable that the attachments 20 each further includes one or more projections 24 extended from each of the protrusions 23, best shown in FIG. 5, for engaging into or with the cavities 38 of the base support member 30, when the shank 22 of the attachment 20 is further rotated relative to the base support member 30, best shown in FIG. 9, and thus for further force-fitting or detachably locking or releasably securing the shank 22 of the attachment 20 to the base support member 30.

In operation, as shown in FIGS. 6-9, the shanks 22 and the protrusions 23 of the various attachments 20 may be selectively engaged through the openings 32 and the notches 33 of the base support member 30 respectively, and the attachments 20 may then be rotated relative to the base support member 30, to engage the shanks 22 thereof into the depressions 37 of the base support member 30, for detachably locking or releasably securing the attachments 20 to the base support member 30.

The attachments 20 may then be further rotated relative to the base support member 30, until the projections 24 of the shanks 22 thereof are engaged into the cavities 38 of the base support member 30 respectively, for further detachably locking or releasably securing the attachments 20 to the base support member 30, and for preventing the attachments 20 from being disengaged from the base support member 30.

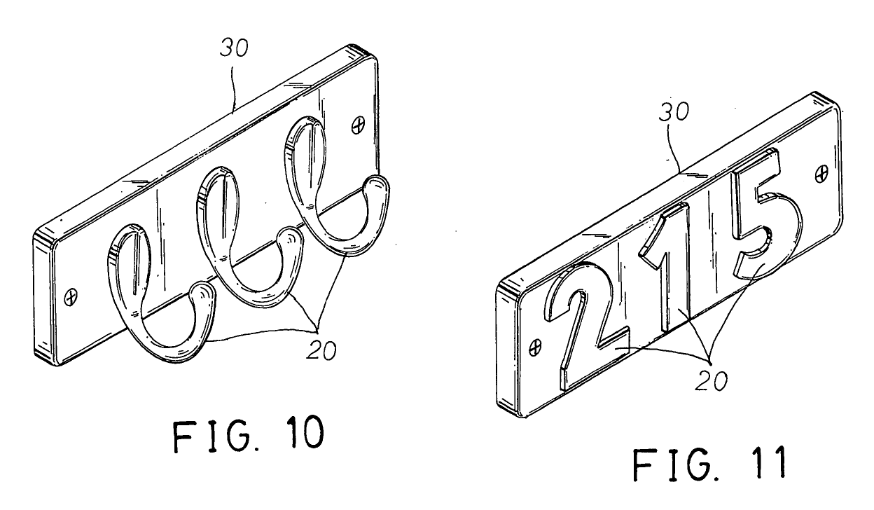

As shown in FIGS. 10-14, the various attachments 20 may be selectively attached to the base support member 30, and may be easily and readily and solidly arranged in various arrangements by the users.

Accordingly, the hanging device in accordance with the present invention includes a solid coupling or solid securing structure for solidly and detachably securing various objects or attachments to the base support member, and for preventing the attachments from being disengaged from the base support member 30.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A hanging device comprising:
a base support member including at least one opening formed therein, and at least one notch formed therein and located beside and communicating with said at least one opening thereof, and including a depression formed in a rear portion thereof, and communicating with said at least one notch thereof, and
an attachment including a shank extended therefrom for engaging into said at least one opening of said base support member, and including at least one protrusion laterally extended from said shank, for engaging into said at least one notch of said base support member, and for engaging into said depression of said base support member by rotating said attachment relative to said base support member, and for detachably locking said shank of said attachment to said base support member.

2. The hanging device as claimed in claim 1, wherein said base support member includes a cavity formed in said rear portion thereof, and communicating with said depression and said at least one notch of said base support member, and said attachment includes at least one projection extended from said at least one protrusion, for engaging into said cavity of said base support member, and for detachably locking said shank of said attachment to said base support member.

3. The hanging device as claimed in claim 1, wherein said attachment is a hook member.

4. The hanging device as claimed in claim 1, wherein said attachment is a numeral member.

5. The hanging device as claimed in claim 1, wherein said attachment is a circular member.

6. The hanging device as claimed in claim 1, wherein said attachment is an arrow member.

7. The hanging device as claimed in claim 1, wherein said base support member includes at least one magnet attached to said rear portion thereof.

8. The hanging device as claimed in claim 7, wherein said base support member includes an adhesive layer attached to said at least one magnet.

9. The hanging device as claimed in claim 7, wherein said base support member includes a recess formed in said rear portion thereof, for receiving said at least one magnet.

10. The hanging device as claimed in claim 1, wherein said base support member includes at least one aperture formed in said rear portion thereof, for receiving a fastener.

11. The hanging device as claimed in claim 1, wherein said base support member includes at least one aperture formed in said rear portion thereof, for receiving a nail.

12. The hanging device as claimed in claim 1, wherein said base support member includes at least one aperture formed in said rear portion thereof, for receiving a sucker member.
